(19) United States
(12) Patent Application Publication
(10) Pub. No.: US 2024/0170693 A1
(43) Pub. Date: May 23, 2024

(54) FUEL BATTERY STACK

(71) Applicant: HONDA MOTOR CO., LTD., Tokyo (JP)

(72) Inventors: Hitoshi NAGASAKI, Tochigi (JP); Takehiro MUGISHIMA, Tochigi (JP); Satoshi YONEZAWA, Tochigi (JP)

(73) Assignee: HONDA MOTOR CO., LTD., Tokyo (JP)

(21) Appl. No.: 17/773,489

(22) PCT Filed: Sep. 9, 2020
(86) PCT No.: PCT/JP2020/034189

§ 371 Date: Apr. 29, 2022

(30) Foreign Application Priority Data
Nov. 12, 2019 (JP) 2019-204810

(51) Int. Cl. H01M 8/04007; H01M 8/2418; H01M 8/2465

(52) U.S. Cl. CPC H01M 8/04074; H01M 8/2418; H01M 8/2465

(57) ABSTRACT

A fuel battery stack includes: fuel battery cells including a first anode electrode and a first cathode electrode on both surfaces of a first electrolyte, the first anode electrode and the first cathode electrode each constituting plural electrode regions divided by division grooves, a plurality of unit cells being constituted by a stacking structure including one electrode region on one surface side of the both surfaces, one electrode region on the other surface side facing the one electrode region, and the first electrolyte, these unit cells being connected in series, a second fuel battery cell including a second anode electrode and a second cathode electrode on both surfaces of a second electrolyte and includes a second conductive portion penetrating the second electrolyte to short-circuit between the second anode and cathode electrode; and a non-conductive separator dividing the first fuel battery cells and the second fuel battery cell, respectively.

### TECHNICAL FIELD

The present invention relates to a fuel battery stack.

### BACKGROUND ART

In general, a fuel battery includes a power generation cell in which an electrode structure provided with an anode electrode and a cathode electrode respectively on both sides of an electrolyte membrane (electrolyte) is sandwiched between separators. This type of power generation cell is used as a fuel battery stack by alternately stacking a predetermined number of the power generation cells with separators interposed therebetween.

In this power generation cell, fuel gas supplied to the anode electrode, for example, gas mainly containing hydrogen (hereinafter also referred to as hydrogen-containing gas) is ionized on an electrocatalyst and moves toward the cathode electrode through the electrolyte. Electrons generated during that time are taken out to an external circuit and used as direct current electric energy. Since oxidant gas, for example, gas mainly containing oxygen or air (hereinafter also referred to as oxygen-containing gas) is supplied to the cathode electrode, hydrogen ions, electrons, and oxygen react to generate water at this cathode electrode.

In a fuel battery stack, it has been pointed out that heat radiation toward outside causes a decrease in temperature in a part or a whole of a power generation cell and dew condensation, which leads to degradation in discharging efficiency of generated water and in power generation performance. In particular, when a fuel battery stack is started in a sub-zero environment, generated water generated in a power generation cell is frozen, which makes it difficult to effectively raise a temperature of the power generation cell, resulting in a decrease in voltage.

In view of such a problem, in Patent Literature 1, a first metal separator and a second metal separator sandwiching an electrode structure are disposed, a conductive member is disposed between these metal separators to form a short-circuit cell by short-circuiting the separators, hydrogen-containing gas and oxygen-containing gas are reacted in the short-circuit cell to generate heat, and heat generated by the heat generation is used to heat and raise a power generation cell in temperature, thereby solving the above problem.

### CITATION LIST

### Patent Literature

Patent Literature 1: JP 4214045 B2

### SUMMARY OF INVENTION

### Technical Problem

However, in an invention described in Patent Literature 1, since a short-circuit cell needs to be disposed, electrically separated from a power generation cell, the short-circuit cell can be disposed at an end of a fuel battery stack but cannot be disposed in between a plurality of power generation cells. Thus, conventionally, a temperature of a cell at an end of a fuel battery stack can be effectively raised, but a temperature in a central part of a fuel battery stack or of an entire fuel battery stack cannot be uniformly raised to improve power generation performance.

An object of the present invention is to provide a fuel battery stack capable of raising a temperature of a power generation cell at an arbitrary portion of the fuel battery stack with a simple and economical configuration.

### Solution to Problem

An embodiment of the present invention relates to a fuel battery stack including at least one first fuel battery cell that includes a first anode electrode and a first cathode electrode on both surfaces of a first electrolyte, the first anode electrode and the first cathode electrode each constituting a plurality of electrode regions divided by division grooves, a plurality of unit cells being constituted by a stacking structure including one electrode region on one surface side of the both surfaces, one electrode region on the other surface side facing the one electrode region, and the first electrolyte, a first conductive portion that electrically connects the electrode region on the one surface side in one of the unit cells and an electrode region on the other surface side in a unit cell arranged adjacent to the one unit cell being included in the first electrolyte, at least one second fuel battery cell that includes a second anode electrode and a second cathode electrode on both surfaces of a second electrolyte and includes a second conductive portion that penetrates the second electrolyte to short-circuit between the second anode electrode and the second cathode electrode, and at least one non-conductive separator in which at least one of a fuel gas passage and an oxidant gas passage dividing the at least one first fuel battery cell and the at least one second fuel battery cell respectively is formed.

In the first fuel battery cell, the first anode electrode and the first cathode electrode disposed on both surfaces of the first electrolyte are divided into the electrode regions by the division grooves, one electrode region on one surface side, one electrode region on the other surface side of a unit cell arranged adjacent to a unit cell including the electrode region on the one surface side, and the first electrolyte constitute a unit cell, and these unit cells are connected by the first conductive portion formed in the first electrolyte. Thus, the unit cells are connected in series, and power is extracted in a planar direction of the first anode electrode and the first cathode electrode constituting the first fuel battery cell.

On the other hand, in the second fuel battery cell, when a current flows in a second anode electrode and the second cathode electrode through the second conductive portion formed in the second electrolyte, the current flows in an electrode structure including the second anode electrode and the second cathode electrode to generate Joule heat there. Thus, by using this Joule heat, the second fuel battery cell can be used as a temperature raising cell.

The second fuel battery cell also has the electrode structure, is supplied with fuel gas and oxidant gas, is consumed in an electrocatalytic layer through an electrochemical reaction, and generates power. Thus, the second fuel battery cell is heated and raised in temperature by a heating effect based on the power generation.

In other words, the second fuel battery cell can heat and raise the first fuel battery cell in temperature by using both Joule heat generated by resistance heating and heat generated by power generation through a chemical reaction.

In the fuel battery stack according to the present embodiment, power is extracted from the first fuel battery cell, and the second fuel battery cell is used for heating and raising the first fuel battery cell in temperature and thus can also be referred to as a dummy fuel battery cell.

Since at least one first fuel battery cell and at least one second fuel battery cell are stacked with a non-conductive separator interposed therebetween, they are electrically separated from each other. Thus, since the second fuel battery cell can be disposed at an arbitrary portion of the fuel battery stack, that is, at an arbitrary position in between a plurality of the first fuel battery cells, the second fuel battery cell can be disposed at a central part of the fuel battery stack, or the like to uniformly raise a temperature of an entire fuel battery stack and improve power generation performance.

As described above, since the power in the fuel battery stack is extracted in the planar direction of the first anode electrode and the first cathode electrode by the first fuel battery cell, even if each fuel battery cell is electrically separated by the separator as described above, a power generation capacity and a power generation function of the fuel battery stack as a whole do not become a problem.

In an embodiment of the present invention, a resistance of an electrode structure of a second fuel battery cell can be made higher than a resistance of an electrode structure of a first fuel battery cell. As a result, Joule heat generated in the second fuel battery cell can be increased, and by using the Joule heat, the first fuel battery cell can be more effectively heated and raised in temperature.

In an another embodiment of the present invention, an electrode structure includes a gas diffusion layer, and a resistance of the gas diffusion layer in the electrode structure of a second fuel battery cell can be made higher than a resistance of the gas diffusion layer in the electrode structure of a first fuel battery cell. As a result, Joule heat generated in the second fuel battery cell can be easily increased, and by using the Joule heat, the cell can be more effectively heated and raised in temperature.

In a further another embodiment of the present invention, a second fuel battery cell can be located in between a plurality of first fuel battery cells. As a result, as described above, a central part of a fuel battery stack and an entire fuel battery stack can be uniformly raised in temperature to improve power generation performance thereof.

### Advantageous Effects of Invention

As described above, according to the present invention, it is possible to provide a fuel battery stack capable of raising a temperature of a fuel battery cell at an arbitrary portion of the fuel battery stack with a simple and economical configuration.

### BRIEF DESCRIPTION OF DRAWINGS

FIG. 1 is a schematic cross-sectional view of a fuel battery stack according to a first embodiment of the present invention.

FIG. 2 is a schematic cross-sectional view of a fuel battery stack according to a second embodiment of the present invention.

FIG. 3 is a schematic diagram illustrating a control method during power generation of a fuel battery stack according to an embodiment of the present invention.

FIG. 4 is a schematic diagram illustrating a control method during heat generation of a fuel battery stack according to an embodiment of the present invention.

### DESCRIPTION OF EMBODIMENTS

Hereinafter, fuel battery stacks according to embodiments of the present invention will be described.

### First Embodiment

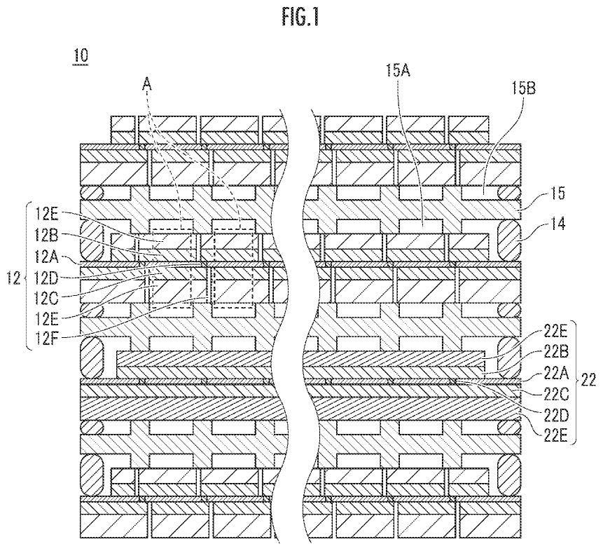

FIG. 1 is a schematic cross-sectional view of a fuel battery stack according to an embodiment of the present invention. As illustrated in FIG. 1, a fuel battery stack 10 according to the present embodiment includes a total of three first fuel battery cells 12 and one second fuel battery cell 22. The second fuel battery cell 22 is disposed at a central part of the three first fuel battery cells 12.

In each of the first fuel battery cells 12, a first anode electrode 12B and a first cathode electrode 12C are disposed respectively on both surfaces of a first electrolyte 12A. Outside the first anode electrode 12B and the first cathode electrode 12C, gas diffusion layers 12E and 12E made of carbon paper or the like are disposed so as to be in contact with respective surfaces of the electrodes. The gas diffusion layers 12E and 12E have an electrocatalytic layer (not illustrated) in which porous carbon particles having platinum-alloys supported on surfaces thereof are uniformly applied. The electrocatalytic layer is joined to each surface of the first electrolyte 12A.

The first anode electrode 12B and the gas diffusion layer 12E (and the electrocatalytic layer not illustrated) on an upper surface side of the first electrolyte 12A and the first cathode electrode 12C and the gas diffusion layer 12E (and the electrocatalytic layer not illustrated) on a lower surface side of the first electrolyte 12A are divided by a plurality of division grooves 12F to form a plurality of regions (hereinafter referred to as “electrode regions”). These electrode regions have a rectangular shape in which an extending direction of the division grooves 12F is a short side and a space between two of the division grooves is a long side. The electrode regions on the upper surface side of the first electrolyte 12A are disposed so as to face the electrode regions on the lower surface side.

A unit cell (power generation cell) A is constituted by a stacking structure including one of the electrode regions on the upper surface side of the first electrolyte 12A, an electrode region on the lower surface side, facing a part of the electrode region on the upper surface side, and the first electrolyte 12A located between these electrode regions.

The first electrolyte 12A is an electrolyte membrane made of proton conductive resin and includes inside a first conductive portion 12D that electrically connects an electrode region on an upper surface side of one unit cell A and an electrode region on a lower surface side of a unit cell adjacent to the one unit cell A. The unit cells A adjacent to each other are electrically connected in series by the first conductive portion 12D. The first conductive portion 12D is formed by locally applying heat to the electrolyte membrane along the extending direction of the division grooves 12F to carbonize the proton conductive resin. The first fuel battery cell 12 can be manufactured based on a method described in WO 2018/124039 A, for example.

In the above configuration, fuel gas is supplied to an anode electrode side, and oxidant gas is supplied to a cathode electrode side, whereby power is generated in each unit cell A, and the unit cells each are connected in series. Therefore, a sum of voltages of each unit cell A is a voltage of the first fuel battery stack 10, and power is extracted in a planar direction of the first anode electrode 12B and the first cathode electrode 12C.

In the present embodiment, as described below, since fuel gas and the like are supplied by a non-conductive separator in which a gas passage having a comb-tooth shaped cross section is formed, a seal 14 is disposed at an end of the separator.

On the other hand, the second fuel battery cell 22 includes a second electrolyte 22A that is an electrolyte membrane made of proton conductive resin, and a second anode electrode 22B and a second cathode electrode 22C disposed on both sides thereof. The second anode electrode 22B and the second cathode electrode 22C do not have the division grooves 12F as in the first fuel battery cell 12 and are disposed over a substantially entire surface of the second electrolyte 22A.

Outside the second anode electrode 22B and the second cathode electrode 22C, a gas diffusion layers 22E, 22E made of carbon paper or the like is disposed, and on a surface of the gas diffusion layer 22E, the electrocatalytic layer in which porous carbon particles having platinum-alloys supported on surfaces thereof are uniformly applied is formed. The electrocatalytic layer is joined to each surface of the second electrolyte 22A. A second conductive portion 22D is formed in the second electrolyte 22A to electrically short-circuit between the second anode electrode 22B and the second cathode electrode 22C.

The second conductive portion 22D is formed, similarly to the first conductive portion 12D, by locally applying heat to the electrolyte membrane along the extending direction of the division grooves 12F to carbonize the proton conductive resin. A shape of the second conductive portion 22D is not limited to this shape and can be changed according to a portion to be heated.

Note that a method for manufacturing the first conductive portion 12D and the second conductive portion 22D is not limited to the above-described manufacturing method in which the proton conductive resin is carbonized and may be formed, for example, by mechanically forming a through-hole in the second electrolyte 22A using a needle-shaped cutting tool, or by forming a through-hole through irradiation with laser light and partial evaporation, followed by filling of the through-hole with a conductive member such as gold, silver, copper, or aluminum.

In the second fuel battery cell 22, when a current flows in the second anode electrode 22B and the second cathode electrode 22C through the second conductive portion 22D formed in the second electrolyte 22A, the current flows in an electrode structure including the second anode electrode 22B and the second cathode electrode 22C and generates Joule heat there. Thus, by using this Joule heat, the second fuel battery cell 22 can be used as a temperature raising cell.

The second fuel battery cell 22 also has the electrode structure, is supplied with fuel gas and oxidant gas, is consumed in the electrocatalytic layer through an electrochemical reaction to generate power. Thus, the second fuel battery cell 22 is heated and raised in temperature by a heating effect based on the power generation.

In other words, the second fuel battery cell 22 can heat and raise the first fuel battery cell 12 in temperature by using both Joule heat generated by resistance heating and heat generated by power generation through a chemical reaction. Since the second fuel battery cell 22 has no division grooves, generated electricity does not require external wiring and is converted into Joule heat inside the second fuel battery cell 22. A calorific value at this time can be designed in advance.

The first fuel battery cell 12 and the second fuel battery cell 22 each have a comb-tooth shape in cross section and are divided by a non-conductive separator 15 with a fuel gas passage formed on one side and an oxidant gas passage formed on the other side.

By disposing the non-conductive separator with a configuration as described above, in the present embodiment, three first fuel battery cells 12 are alternately stacked such that the anode electrode and the cathode electrode face each other.

The number of the first fuel battery cells 12 is not limited to three and may be set to any number as necessary. Similarly, the number of the second fuel battery cells 22 is not limited to one and may be set to any number as necessary.

It is preferred that forms of the first fuel battery cell 12 and the second fuel battery cell 22 be solid in electrolyte and be a solid polymer cell and a solid oxide cell from a viewpoint that the first conductive portion and the second conductive portion can be easily formed.

According to the present embodiment, since three first fuel battery cells 12 and one second fuel battery cell 22 are stacked with the non-conductive separator 15 interposed therebetween, they are electrically separated from one another. Thus, the second fuel battery cell 22 can be disposed at an arbitrary portion of three fuel battery stacks 10, that is, at an arbitrary position in between three first fuel battery cells 12, specifically, as in the present embodiment, at a central part of the fuel battery stack or the like to uniformly raise a temperature of an entire fuel battery stack and improve power generation performance.

Further, according to the present embodiment, the second anode electrode 22B and the second cathode electrode 22C of the second fuel battery cell 22 do not have the division grooves 12F as in the first fuel battery cell 12 and are disposed over an entire surface of the second electrolyte 22A, so that a temperature of an entire surface of the second fuel battery cell 22 can be raised to raise a temperature of an entire surface of the first fuel battery cell 12. For this reason, a difference in temperature is not caused among the unit cells A of the first fuel battery cell 12, so that power generation performance can be improved.

As described above, since the power in the fuel battery stack 10 is extracted in the planar direction of the first anode electrode 12B and the first cathode electrode 12C by three first fuel battery cells 12, a power generation capacity and a power generation function of the fuel battery stack 10 as a whole do not become a problem.

In the present embodiment, a resistance of the electrode structure including the second anode electrode 22B and the second cathode electrode 22C of the second fuel battery cell 22 is preferably made higher than a resistance of an electrode structure of the first fuel battery cell 12. Specifically, a resistance of the gas diffusion layer 22E in the electrode structure of the second fuel battery cell 22 is made higher than a resistance of the gas diffusion layer 12E in the electrode structure of the first fuel battery cell 12. As a result, Joule heat generated in the second fuel battery cell 22 can be easily increased, and by using the Joule heat, the first fuel battery cell 12 can be more effectively heated and raised in temperature.

In this case, it is preferred that the gas diffusion layer 22E of the second fuel battery cell 22 be made of carbon paper or the like, high in resin content, or carbon paper or the like, manufactured thinner than usual, and the gas diffusion layer 12E of the first fuel battery cell 12 be made of carbon paper or the like, low in resin content. This makes it possible to more easily increase the resistance of the electrode structure of the second fuel battery cell 22 than the resistance of the electrode structure of the first fuel battery cell 12.

The resistance of the electrode structure of the second fuel battery cell 22 can also be changed by applying a high resistor, for example, resin or ceramic to the second anode electrode 22B and the second cathode electrode 22C.

### Second Embodiment

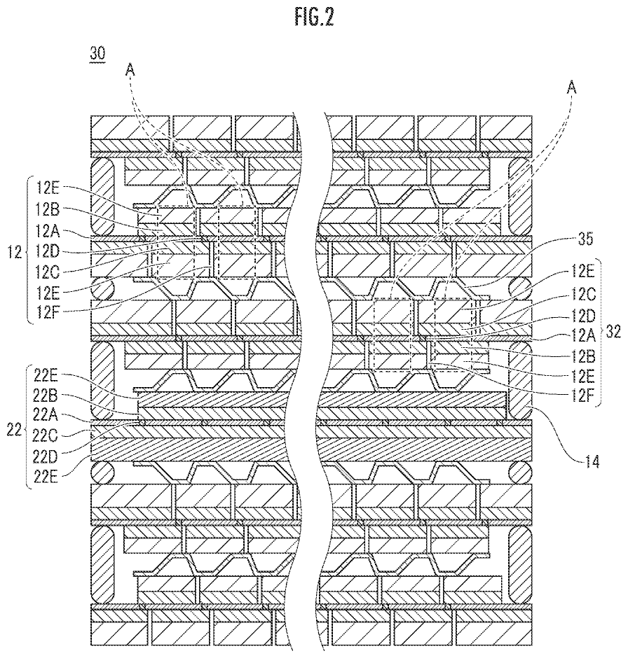

FIG. 2 is a schematic cross-sectional view of a fuel battery stack according to an embodiment of the present invention.

In the present embodiment, a cross section of a separator 35 has a wave shape, and either fuel gas or oxidant gas flows through an adjacent space. Thus, in the present embodiment, unlike the case described in the first embodiment, an anode electrode and an anode electrode, or a cathode electrode and a cathode electrode are alternately stacked so as to face each other.

For example, in the present embodiment, a sub-first fuel battery cell 32 in which the first anode electrode 12B is disposed so as to face the first anode electrode 12B of the first fuel battery cell 12 in the first embodiment, and the first cathode electrode 12C is disposed so as to face the first cathode electrode 12C of the first fuel battery cell 12 is disposed. This means that, in the present embodiment, a fuel battery stack 30 includes two first fuel battery cells 12, three sub-first fuel battery cells 32, and one second fuel battery cell 22.

The second fuel battery cell 22 is disposed in between the first fuel battery cells 12 and the sub-first fuel battery cells 32 and at a central part of the fuel battery stack 30. As in the first embodiment, the second anode electrode 22B and the second cathode electrode 22C of the second fuel battery cell 22 do not have the division grooves 12F as in the first fuel battery cell 12 and are disposed over the entire surface of the electrolyte 22A.

Also in the present embodiment, since two first fuel battery cells 12, three sub-first fuel battery cells 32, and one second fuel battery cell 22 are stacked with the non-conductive separator 35 interposed therebetween, they are electrically separated from one another. Thus, the second fuel battery cell 22 can be disposed at an arbitrary portion of the fuel battery stack 30, that is, at an arbitrary position in between two first fuel battery cells 12 and three sub-first fuel battery cells 32, specifically, as in the present embodiment, at the central part of the fuel battery stack 30 or the like to uniformly raise a temperature of the entire fuel battery stack 30 and improve power generation performance.

Further, according to the present embodiment, as in the first embodiment, the second anode electrode 22B and the second cathode electrode 22C of the second fuel battery cell 22 do not have the division grooves 12F as in the first fuel battery cell 12 and are disposed over the entire surface of the second electrolyte 22A, so that a temperature of the entire surface of the second fuel battery cell 22 can be raised to raise a temperature of the entire surface of the first fuel battery cell 12. For this reason, a difference in temperature is not caused among the unit cells A of the first fuel battery cell 12, so that power generation performance can be improved.

As described above, since the power in the fuel battery stack 30 is extracted in the planar direction of the first anode electrode 12B and the first cathode electrode 12C by two first fuel battery cells 12 and three sub-first fuel battery cells 32, a power generation capacity and a power generation function of the fuel battery stack 30 as a whole do not become a problem.

Further, the second fuel battery cell 22 can heat and raise the first fuel battery cell 12 and the sub-first fuel battery cell 32 in temperature by using both Joule heat generated by resistance heating and heat generated by power generation through a chemical reaction.

Other features are similar to those of the first embodiment, and thus the description thereof will be omitted.

### Third Embodiment

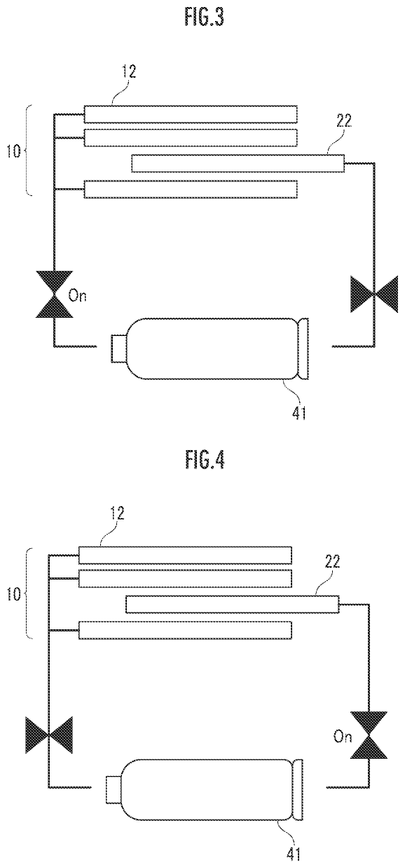

FIG. 3 is a schematic diagram illustrating a control method during power generation of the fuel battery stack 10 according to the present embodiment, and FIG. 4 is a schematic diagram illustrating a control method during heat generation of the fuel battery stack 10 according to the present embodiment.

As illustrated in FIG. 3, during power generation of the fuel battery stack 10, fuel gas such as hydrogen-containing gas, oxidant gas or oxygen-containing gas such as air, and a cooling medium such as pure water, ethylene glycol, or oil are supplied from a fuel tank 41 to a plurality of the first fuel battery cells 12. As a result, in the electrode structure, the fuel gas supplied to the first anode electrode 12B and the oxidant gas supplied to the first cathode electrode 12C are consumed in an electrocatalytic layer through an electrochemical reaction to generate power.

On the other hand, as illustrated in FIG. 4, during heat generation of the fuel battery stack 10, fuel gas such as hydrogen-containing gas, oxidant gas or oxygen-containing gas such as air, and a cooling medium such as pure water, ethylene glycol, or oil are supplied from the fuel tank 41 to the second fuel battery cell 22. As a result, in the electrode structure, the fuel gas supplied to the second anode electrode 22B and the oxidant gas supplied to the second cathode electrode 22C are consumed in the electrocatalytic layer through an electrochemical reaction to generate power. Accordingly, also in the second fuel battery cell 22, the fuel battery stack 10 can be heated and raised in temperature by heat generated based on power generation.

On the other hand, the second fuel battery cell 22 includes the electrode structure including a high-resistance gas diffusion layer and has the second anode electrode 22B and the second cathode electrode 22C short-circuited by the second conductive portion 22D. Thus, when a current flows in the second anode electrode 22B and the second cathode electrode 22C through the second conductive portion 22D of the second fuel battery cell 22, the current flows in the electrode structure and generates Joule heat there. This contributes to heating and raising the fuel battery stack 10 in temperature.

In other words, in the second fuel battery cell 22, the fuel battery stack 10 can be heated and raised in temperature by using both heat generated through a chemical reaction as a fuel battery and heat generated by Joule heat due to resistance.

Although some embodiments of the present invention have been described above, these embodiments have been presented as examples and are not intended to limit the scope of the invention. These novel embodiments can be implemented in various other forms, and various omissions, substitutions, and changes can be made without departing from the spirit of the invention. These embodiments and their modifications fall within the scope and spirit of the invention and are included in the invention provided in the claims and the scope of equivalents thereof.

### REFERENCE SIGNS LIST

10, 30 fuel battery stack
12 first fuel battery cell
12A first electrolyte
12B first anode electrode
12C first cathode electrode
12D first conductive portion
12E first gas diffusion layer
12F division groove
14 seal
15, 35 separator
22 second fuel battery cell
22A second electrolyte
22B second anode electrode
22C second cathode electrode
22D second conductive portion
22E second gas diffusion layer
32 sub-first fuel battery cell
41 fuel tank

1. A fuel battery stack comprising:
at least one first fuel battery cell that includes a first anode electrode and a first cathode electrode on both surfaces of a first electrolyte, the first anode electrode and the first cathode electrode each constituting a plurality of electrode regions divided by division grooves, a plurality of unit cells being constituted by a stacking structure including one electrode region on one surface side of the both surfaces, one electrode region on the other surface side facing the one electrode region, and the first electrolyte, a first conductive portion that electrically connects the electrode region on the one surface side in one of the unit cells and an electrode region on the other surface side in a unit cell arranged adjacent to the one unit cell being included in the first electrolyte;
at least one second fuel battery cell that includes a second anode electrode and a second cathode electrode on both surfaces of a second electrolyte and includes a second conductive portion that penetrates the second electrolyte to short-circuit between the second anode electrode and the second cathode electrode; and
at least one non-conductive separator in which at least one of a fuel gas passage and an oxidant gas passage dividing the at least one first fuel battery cell and the at least one second fuel battery cell respectively is formed.

2. The fuel battery stack according to claim 1, wherein a resistance of an electrode structure of the at least one second fuel battery cell is higher than a resistance of an electrode structure of the at least one first fuel battery cell.

3. The fuel battery stack according to claim 2, wherein the electrode structures include gas diffusion layers, and a resistance of the gas diffusion layers in the electrode structure of the second fuel battery cell is higher than a resistance of the gas diffusion layers in the electrode structure of the first fuel battery cell.

4. The fuel battery stack according to claim 1, wherein the at least one second fuel battery cell is located between the first fuel battery cells.
